(19) United States
(12) Patent Application Publication
(10) Pub. No.: US 2004/0066133 A1
(43) Pub. Date: Apr. 8, 2004

(54) Light-emitting device and field emission display having such light-emitting devices

(75) Inventor: Yukihisa Takeuchi, Nishikamo-Gun (JP)

Correspondence Address: BURR & BROWN, PO BOX 7068, SYRACUSE, NY, 13261-7068, US

(73) Assignee: NGK Insulators, Ltd., Nagoya-City (JP)

(21) Appl. No.: 10/673,384

(22) Filed: Sep. 26, 2003

(30) Foreign Application Priority Data
Sep. 30, 2002 (JP) 2002-286792

(51) Int. Cl. H01J 1/62

(52) U.S. Cl. 313/495

(57) ABSTRACT

When a pulsed voltage is applied to a drive electrode, an electric field is concentrated in the vicinity of a slit, producing a field emission phenomenon. The emitted electrons are applied through an electrically conductive coating layer and an electron passage layer to a fluorescent layer when a bias voltage is applied to a transparent electrode. The fluorescent layer is excited to emit light through the transparent electrode as indicated by the arrows. Light-emitting devices may be arranged in a two-dimensional array, providing a field emission display.

This application claims the benefit of Japanese Application No. 2002-286792 filed Sep. 30, 2002, the entirety of which is incorporated herein by reference.

### BACKGROUND OF THE INVENTION

1. Field of the Invention

The present invention relates to a light-emitting device and a field emission display having such light-emitting devices.

2. Description of the Related Art

In recent years, various applications such as field emission displays (FED) and back lights employ electron emitters having drive electrodes and ground electrodes (see, for example, Japanese laid-open patent publication No. 1-311533; Japanese laid-open patent publication No. 7-147131; Japanese laid-open patent publication No. 2000-285801; Japanese patent publication No. 46-20944; Japanese patent publication No. 44-26125; Yasuoka, Ishi “Pulsed electron source using a ferroelectric cathode”, J. Appl. Phys., Vol. 68, No. 5, p. 546-550 (1999); V. F. Puchkarev, G. A. Mesyats, “On the mechanism of emission from the ferroelectric ceramic cathode”; J. Appl. Phys., Vol. 78. No. 9, Nov. 1995, p. 5633-5637; H. Riege, “Electron emission ferroelectric—a review”, Nucl. Instr. And Meth. A340, p. 80-89 (1994)). If such electron emitters are incorporated in an FED, then they are arranged in a two-dimensional array, and a plurality of fluorescent bodies are disposed at predetermined spaced intervals in association with the respective electron emitters.

However, the straightness of conventional general electron emitters as disclosed in those documents, i.e., the extent to which emitted electrons travel straight toward a given object (e.g., a fluorescent body), is poor. For maintaining a desired current density with emitted electrons, it is necessary to apply a relatively high voltage to the electron emitter.

If conventional general electron emitters are incorporated in an FED, then the crosstalk is relatively large, i.e., the tendency that emitted electrons are applied to fluorescent bodies that are positioned adjacent to a fluorescent body corresponding to the emitted electrons is high, because the straightness of the electron emitters is poor. As a result, it is difficult to reduce the pitch of fluorescent bodies, and a grid needs to be provided for preventing electrons from being applied to adjacent fluorescent bodies.

### SUMMARY OF THE INVENTION

It is an object of the present invention to provide a light-emitting device which will not cause crosstalk and can emit light at a very low drive voltage in an ambient atmosphere that is not required to be kept in a vacuum, i.e., in an ambient atmosphere under the atmospheric pressure, and a field emission display having such light-emitting devices.

A light-emitting device according to the present invention comprises:

an electric field receiving member made of a dielectric material;

a first electrode disposed on one surface of the electric field receiving member;

a second electrode disposed on the one surface of the electric field receiving member, the second electrode and the first electrode jointly defining a slit;

an electron passage layer disposed on the first electrode, the second electrode, and the slit, the electron passage layer being resistant to a predetermined voltage when the predetermined voltage is applied thereto, the electron passage layer being made of a material having such characteristics as to pass electrons therethrough;

a fluorescent layer disposed on the electron passage layer; and

a transparent electrode disposed on the fluorescent layer or a third electrode disposed at a predetermined spaced interval from the fluorescent layer.

According to the present invention, when a pulsed voltage is applied to the first or second electrode, an electric field is concentrated in the vicinity of the slit, producing a field emission phenomenon. The emitted electrons are applied through the electron passage layer to the fluorescent layer by a bias voltage that is applied to the transparent electrode or the third electrode. The fluorescent layer is excited to emit light.

Since the emitted electrons move only between the electron passage layer and the fluorescent layer, it is not necessary to take into account the straightness of the electrons, i.e., crosstalk, when the light-emitting device is in use. Accordingly, a voltage that is applied to achieve a desired current density is lower than required for an electron emitter, so that the light-emitting device has greatly reduced power consumption. Because the light-emitting device emits light by itself, it is not necessary to emit electrons into a vacuum space and apply the electrons to a corresponding fluorescent body. The light-emitting device can thus be used in an ambient atmosphere under the atmospheric pressure. As a consequence, the light-emitting device can emit light at a very low drive voltage under the atmospheric pressure. Inasmuch as the first and second electrodes, etc. can be formed on the electric field receiving member by thick-film printing, the light-emitting device according to the present invention is preferable also from the standpoints of durability and cost reduction.

According to another aspect of the present invention, an light-emitting device comprises:

an electric field receiving member made of a dielectric material;

a first electrode disposed on one surface of the electric field receiving member;

a second electrode disposed on the one surface of the electric field receiving member, the second electrode and the first electrode jointly defining a slit;

a first electron passage layer disposed on the first electrode, the second electrode, and the slit, the first electron passage layer being resistant to a predetermined voltage when the predetermined voltage is applied thereto, the first electron passage layer being made of a material having such characteristics as to pass electrons therethrough;

a third electrode and a fourth electrode which are disposed on the first electron passage layer, for emitting electrons which are emitted from the first electron passage layer;

a second electron passage layer disposed on the first electron passage layer, the third electrode, and the fourth electrode, the second electron passage layer being resistant to a predetermined voltage when the predetermined voltage is applied thereto, the second electron passage layer being made of a material having such characteristics as to pass electrons therethrough;

a fluorescent layer disposed on the second electron passage layer; and

a transparent electrode disposed on the fluorescent layer or a fifth electrode disposed at a predetermined spaced interval from the fluorescent layer.

According to the present invention, when a pulsed voltage is applied to the first or second electrode, an electric field is concentrated in the vicinity of the slit, producing a field emission phenomenon. The emitted electrons are applied through the first and second electron passage layers to the fluorescent layer by a bias voltage that is applied to the transparent electrode or the fifth electrode, while the emission of electrons is being controlled by the third and fourth electrodes. The fluorescent layer is excited to emit light.

Since the emitted electrons move only from the first electron passage layer to the second fluorescent layer, it is not necessary to take into account the straightness of the electrons, i.e., crosstalk, when the electron emitter is in use. Accordingly, a voltage that is applied to achieve a desired current density is lower than required for an electron emitter, so that the light-emitting device has greatly reduced power consumption. Because the light-emitting device emits light by itself, it is not necessary to emit electrons into a vacuum space and apply the electrons to a corresponding fluorescent body. The light-emitting device can thus be used in an ambient atmosphere under the atmospheric pressure. As a consequence, the light-emitting device can emit light at a very low drive voltage under the atmospheric pressure. Furthermore, since the emission of electrons is controlled by the third and fourth electrodes, desired light emission characteristics can easily be obtained. Inasmuch as the first and second electrodes, etc. can be formed on the electric field receiving member by thick-film printing, the light-emitting device according to the present invention is preferable also from the standpoints of durability and cost reduction.

In order to further reduce the voltage applied to the light-emitting device, the light-emitting device preferably further comprises an electrically conductive coating layer interposed between the first electrode, the second electrode, and the slit, and the electron passage layer.

In order to concentrate the electric field for facilitating the emission of electrons, at least one of the first electrode and the second electrode should preferably have at least one of a convexity and a concavity. The convexity and the concavity are formed regularly or irregularly to a desired shape with at least one of a straight line and a curved line. If the convexity and the concavity are formed regularly or irregularly with a straight line only, at least one of the first electrode and the second electrode has an angular portion with an acute angle.

In order to concentrate the electric field for facilitating the emission of electrons, the light-emitting device may comprise at least one of a pinhole defined in at least one of the first electrode and the second electrode, and a land disposed in the slit in electrically insulated relation to the first electrode and the second electrode and made of a material which is the same as the material of the first electrode and the second electrode. The pinhole and the land are also formed regularly or irregularly to a desired shape with at least one of a straight line and a curved line.

In order to greatly reduce the applied voltage, the electric field receiving member has a specific dielectric constant of 1000 or greater, and/or the slit has a width in a range between 0.1 μm and 500 μm. In order to further reduce the applied voltage, the slit has a width in a range between 0.1 μm and 50 μm, or preferably the slit a width in a range between 0.1 μm and 10 μm. More preferably, the slit has a width in a range between 0.1 μm and 1 μm. The electrons can be emitted by a low applied voltage such as of about 10 V.

For achieving easier machinability and insulation between the first electrode and the second electrode, the width of the slit may have a lower limit of 0.1 μm. For emitting electrons at a lower voltage, reducing the size of the circuit, and reducing the cost, and from the standpoint of the service life of the drive electrodes (the first or second electrode), the width of the slit may have an upper limit of 1 μm.

A field emission display according to he present invention comprises a two-dimensional array of light-emitting devices, each of the light-emitting devices comprising:

an electric field receiving member made of a dielectric material;

a first electrode disposed on one surface of the electric field receiving member;

a second electrode disposed on the one surface of the electric field receiving member, the second electrode and the first electrode jointly defining a slit;

an electron passage layer disposed on the first electrode, the second electrode, and the slit, the electron passage layer being resistant to a predetermined voltage when the predetermined voltage is applied thereto, the electron passage layer being made of a material having such characteristics as to pass electrons therethrough;

a fluorescent layer disposed on the electron passage layer; and

a transparent electrode disposed on the fluorescent layer or a third electrode disposed at a predetermined spaced interval from the fluorescent layer.

According to the present invention, since the light-emitting devices emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light-emitting devices can be used under the atmospheric pressure, the FED is not required to have a vacuum space therein, a feature which is very advantageous for making the FED low in profile.

Another field emission display according to the present invention comprises a two-dimensional array of light-emitting devices, each of the light-emitting devices comprising:

an electric field receiving member made of a dielectric material;

a first electrode disposed on one surface of the electric field receiving member;

a second electrode disposed on the one surface of the electric field receiving member, the second electrode and the first electrode jointly defining a slit;

a first electron passage layer disposed on the first electrode, the second electrode, and the slit, the first electron passage layer being resistant to a predetermined voltage when the predetermined voltage is applied thereto, the first electron passage layer being made of a material having such characteristics as to pass electrons therethrough;

a third electrode and a fourth electrode which are disposed on the first electron passage layer, for emitting electrons which are emitted from the first electron passage layer;

a second electron passage layer disposed on the first electron passage layer, the third electrode, and the fourth electrode, the second electron passage layer being resistant to a predetermined voltage when the predetermined voltage is applied thereto, the second electron passage layer being made of a material having such characteristics as to pass electrons therethrough;

a fluorescent layer disposed on the second electron passage layer; and

a transparent electrode disposed on the fluorescent layer or a fifth electrode disposed at a predetermined spaced interval from the fluorescent layer.

According to the present invention, since the light-emitting devices emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light-emitting devices can be used under the atmospheric pressure, the FED is not required to have a vacuum space therein, a feature which is very advantageous for making the FED low in profile. Because the emission of electrons is controlled by the third and fourth electrodes in the individual light-emitting devices, desired light emission characteristics are easily obtained, allowing the FED to display information further well.

Preferably, the field emission display further comprises a substrate, the two-dimensional array of light-emitting devices being integrally formed with the substrate.

Said electric fielf receiving member may be of a pizoelectric material, an anti-ferroelectric material, or an electrostrictive material.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1A is a vertical longitudinal sectional view of a light-emitting device according to a first embodiment of the present invention.

FIG. 1B is a cross-sectional view taken alone line IB-IB of FIG. 1A.

FIG. 2A is a vertical longitudinal sectional view of a light-emitting device according to a second embodiment of the present invention.

FIG. 2B is a cross-sectional view taken alone line IIB-IIB of FIG. 2A.

FIG. 3 is an enlarged microscopic photographic representation of a portion of the light-emitting device shown in FIG. 2B.

FIG. 4 is a diagram illustrating the enlarged microscopic photographic representation shown in FIG. 3.

FIG. 5A is a vertical longitudinal sectional view of a light-emitting device according to a third embodiment of the present invention.

FIG. 5B is a cross-sectional view taken alone line VB-VB of FIG. 5A.

FIG. 6A is a vertical longitudinal sectional view of a light-emitting device according to a fourth embodiment of the present invention.

FIG. 6B is a cross-sectional view taken alone line VIB-VIB of FIG. 6A.

FIG. 7A is a vertical longitudinal sectional view of a light-emitting device according to a fifth embodiment of the present invention.

FIG. 7B is a cross-sectional view taken alone line VIIB-VIIB of FIG. 7A.

FIG. 8A is a vertical longitudinal sectional view of a light-emitting device according to a sixth embodiment of the present invention.

FIG. 8B is a cross-sectional view taken alone line VIIIB-VIIIB of FIG. 8A.

FIG. 9A is a vertical longitudinal sectional view of a light-emitting device according to a seventh embodiment of the present invention.

FIG. 9B is a cross-sectional view taken alone line IXB-IXB of FIG. 9A.

FIG. 10A is a vertical longitudinal sectional view of a light-emitting device according to an eighth embodiment of the present invention.

FIG. 10B is a cross-sectional view taken alone line XB-XB of FIG. 10A.

FIG. 11A is a vertical longitudinal sectional view of a light-emitting device according to a ninth embodiment of the present invention.

FIG. 11B is a cross-sectional view taken alone line XIB-XIB of FIG. 11A.

FIG. 12 is a view of an FED according to an embodiment of the present invention.

### DESCRIPTION OF THE PREFERRED EMBODIMENTS

Embodiments of a light-emitting device according to the present invention and a field emission display having such light-emitting devices will be described in detail below with reference to the drawings. Identical parts are denoted by identical reference characters throughout views.

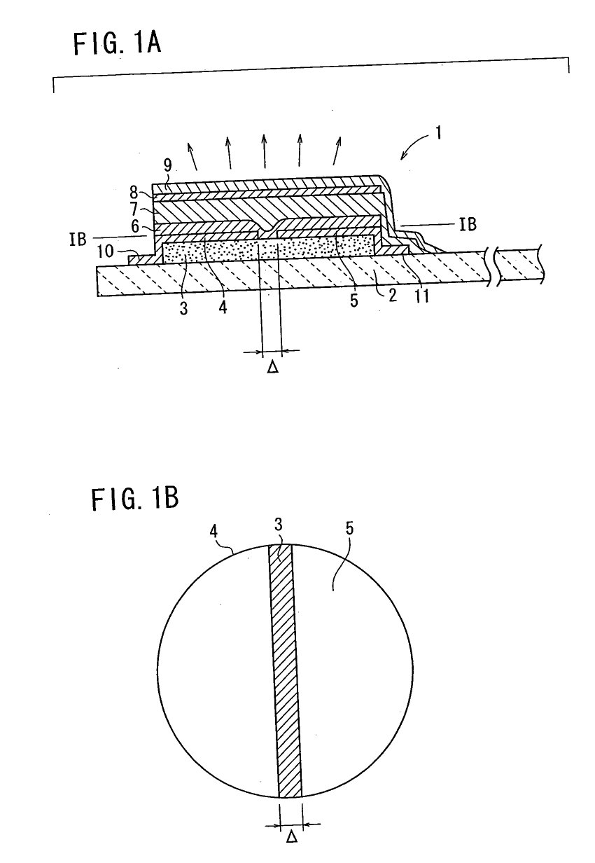

FIG. 1A is a vertical longitudinal sectional view of a light-emitting device according to a first embodiment of the present invention, and FIG. 1B is a cross-sectional view taken alone line IB-IB of FIG. 1A. A light-emitting device 1 according to the present embodiment is formed on a substrate 2, and has an electric field receiving member 3 made of a dielectric material, a drive electrode 4 as a first electrode disposed on one surface of the electric field receiving member 3, a common electrode 5 as a second electrode, the common electrode 5 and the drive electrode 4 jointly defining a slit, an electrically conductive coating layer 6 disposed on the drive electrode 4, the common electrode 5, and the slit, an electron passage layer 7 disposed on the electrically conductive coating layer 6, a fluorescent layer 8 disposed on the electron passage layer 7, and a transparent electrode 9 disposed on the fluorescent layer 8.

The substrate 2 should preferably be made of an electrically insulating material for electrically isolating an interconnection 10 electrically connected to the drive electrode 4 and an interconnection 11 electrically connected to the common electrode 5 from each other.

The substrate 2 may thus be made of a material such as an enameled material, e.g., a highly heat-resistant metal whose surface is covered with a ceramics material such as glass or the like. However, the substrate 2 is most preferably be made of ceramics.

The ceramics that the substrate 4 may be made of includes stabilized zirconium oxide, aluminum oxide, magnesium oxide, titanium oxide, spinel, mullite, aluminum nitride, silicon nitride, glass, and mixtures thereof. Of these materials, aluminum oxide and stabilized zirconium oxide are preferable from the standpoint of strength and rigidity. In particular, stabilized zirconium oxide is preferable as the mechanical strength is high, the tenacity is high, and its chemical reaction with the drive electrode 4 and the common electrode 5 is relatively low. Stabilized zirconium oxide includes stabilized zirconium oxide and partially stabilized zirconium oxide. Since stabilized zirconium oxide has a crystalline structure such as a cubic system, no phase transition occurs therein.

Zirconium oxide undergoes a phase transition between a monoclinic system and a cubic system at about 1000° C., and tends to crack upon such a phase transition. Stabilized zirconium oxide contains 1-30 mol. % of a stabilizer such as calcium oxide, magnesium oxide, yttrium oxide, scandium oxide, ytterbium oxide, cerium oxide, an oxide of a rare earth metal, or the like. It is preferable for the stabilizer to contain yttrium oxide in order to increase the mechanical strength of the substrate 2. In such a case, the stabilizer should preferably contain 1.5-6-mol. %, more preferably 2-4 mol. % of yttrium oxide, and further contain 0.1-5 mol. % of aluminum of oxide.

The crystalline system may be a mixture of a cubic system and a monoclinic system, a mixture of a tetragonal system and a monoclinic system, a mixture of a cubic system, a tetragonal system, and a monoclinic system, or the like. Of these systems, the crystalline system should most preferably be a tetragonal system or a mixture of a tetragonal system and a cubic system from the standpoint of strength, tenacity, and durability.

If the substrate 2 is made of ceramics, then the substrate 2 is made up of a relatively large number of crystal grains. In order to increase the mechanical strength of the substrate 2, the crystal grains should preferably have an average grain size in the range from 0.05 to 2 μm, more preferably in the range from 0.1 to 1 μm.

The dielectric material of the electric field receiving member 3 preferably comprises a dielectric material having a relatively high specific dielectric constant, e.g., 1000 or greater. Such a dielectric material may be barium titanate, lead zirconate, lead magnesium niobate, lead nickel niobate, lead zinc niobate, lead manganese niobate, lead magnesium tantalate, lead nickel tantalate, lead antimony tinate, lead titanate, barium titanate, lead magnesium tungstenate, lead cobalt niobate, etc., ceramics containing a desired combination of these compounds, materials whose main constituent contains 50 weight % or more of these compounds, or materials containing the above ceramics and oxides of lanthanum, calcium, strontium, molybdenum, tungsten, barium, niobium, zinc, nickel, manganese, etc., any combinations thereof, or other compounds added thereto. For example, a two-component n-PMN-mPT compound (n, m represent molar ratios) of lead magnesium niobate (PMN) and lead titanate (PT) has its Curie point lowered and its specific dielectric constant increased at room temperature when the molar ratio of PMN is increased. Particularly, if n=0.85−1.0, m=1.0−n, then the specific dielectric constant has preferably a value of 3000 or higher. For example, if n=0.91, m=0.09, then the specific dielectric constant of 15000 is achieved, and if n=0.95, m=0.05, the specific dielectric constant of 20000 at room temperature is achieved. A three-component compound of lead magnesium niobate (PMN), lead titanate (PT), and lead zirconate (PZ) may have its specific dielectric constant increased by making the compound have a composition in the vicinity of a morphotropic phase boundary (MPB) between a tetragonal system and a pseudo-cubic system or a tetragonal system and a rhombohedral system, as well as by increasing the molar ratio of PMN. For example, the specific dielectric constant of 5500 is achieved preferably with PMN:PT:PZ=0.375:0.375:0.25, and the specific dielectric constant of 4500 is achieved preferably with PMN:PT:PZ=0.5:0.375:0.125. It is also preferable to increase the dielectric constant by mixing the above dielectric materials with a metal such as platinum insofar as electric insulation is maintained. For example, the dielectric materials are mixed with 20 weight % of platinum.

Each of the drive electrode 4 and the common electrode 5 is of a semicircular shape and is made of Au in the form of a film having a thickness of 3 μm. For producing a field emission phenomenon, the width Δ of the slit is selected to be 500 μm or less. If the light-emitting device according to the present invention is driven by a driver IC for use in commercially available plasma displays, phosphoric display tubes, or liquid-crystal displays, then the width Δ of the slit should preferably 20 μm or less.

A pulsed voltage is applied to the drive electrode 4 from a power supply (not shown) through an interconnection 10 which extends from the reverse side of the substrate 2. The common electrode 5 is kept at a predetermined potential (e.g., a ground potential) through an interconnection 11 which extends from the reverse side of the substrate 2. If the common electrode S is kept at the ground potential, then it is preferable to connect a resistor between the common electrode 5 and ground.

The electrically conductive coating layer 6 serves to further lower the voltage applied to the light-emitting device 1, and comprises a layer of carbon having a thickness of 3 μm, for example. However, the electrically conductive coating layer 6 may be made of an electric conductor that is resistant to a high-temperature oxidizing atmosphere, e.g., a pure metal, an alloy, a mixture of insulating ceramics and a pure metal, a mixture of insulating ceramics and an alloy, or the like. Preferably, the electrically conductive coating layer 6 should be made of a precious metal having a high melting point such as platinum, palladium, rhodium, molybdenum, or the like, a material whose main component comprises an alloy of silver and palladium, an alloy of silver and platinum, an alloy of platinum and palladium, or the like, or a cermet of platinum and a ceramics material. More preferably, the electrically conductive coating layer 6 should be made of a material whose main component comprises platinum or a platinum-based alloy. The electrically conductive coating layer 6 may also be made of a graphite material such as thin-film diamond, diamond-like carbon, carbon nanotube, for example. The ceramics material to be added to the electrically conductive coating layer material should preferably be of a proportion ranging from 5 to 30 volume %. The electrically conductive coating layer 6 should preferably have a resistance ranging from several kilohms to 100 kilohms. The electrically conductive coating layer 6 is formed of evaporated carbon (a specific example is an evaporated layer of “CARBON 5PC” manufactured by Sanyu Kogyo Co.), filled carbon (a specific example is a filled layer of “FW200” manufactured by Degussa Co.), printed carbon, or the like.

The electron passage layer 7 is made of a material which is resistant to a predetermined voltage (which may be several hundreds volts or lower if the fluorescent layer 8 is of a low-voltage type, and several kV or higher if the fluorescent layer 8 is of a high-voltage type) when the voltage is applied to the electron passage layer 7, and which has such characteristics as to pass electrons therethrough. The material may have a dielectric constant lower than dielectric materials, and may specifically be amorphous SiOx, porous polysilicon, alumina, or the like. The electron passage layer 7 may also be in the form of an insulating layer on a porous material, a layer of carbon having a diamond structure whose resistance can be adjusted by the introducing of an impurity thereinto, a layer of carbon having a graphite structure, and a high-resistance layer such as of diamond-like carbon, carbon nanotube, or the like.

The fluorescent layer 8 is made of a known phosphor for use in color displays. The transparent electrode 9 is preferably made of indium tin oxide (ITO). A bias voltage+Vb is applied to the transparent electrode 9.

Operation of the light-emitting device according to the present embodiment will be described below. When a pulsed voltage is applied to the drive electrode 4, an electric field is concentrated in the vicinity of the slit, producing a field emission phenomenon. The emitted electrons are applied through the electrically conductive coating layer 6 and the electron passage layer 7 to the fluorescent layer 8 when a bias voltage is applied to the transparent electrode 9. The fluorescent layer 8 is excited to emit light through the transparent electrode 9 as indicated by the arrows.

Since the emitted electrons move from the electrically conductive coating layer 6 only to the fluorescent layer 8, it is not necessary to take into account the straightness of the electrons, i.e., crosstalk, when the light-emitting device is in use. Accordingly, a voltage that is applied to achieve a desired current density is lower than required for an electron emitter, so that the light-emitting device has greatly reduced power consumption. Because the light-emitting device 1 emits light by itself, it is not necessary to emit electrons into a vacuum space and apply the electrons to a corresponding fluorescent body. The light-emitting device according to the present embodiment can thus be used in an ambient atmosphere under the atmospheric pressure. As a consequence, the light-emitting device can emit light at a very low drive voltage under the atmospheric pressure. Inasmuch as the drive electrode 4 and the common electrode 5, etc. can be formed on the electric field receiving member by thick-film printing, the light-emitting device according to the present invention is preferable also from the standpoints of durability and cost reduction.

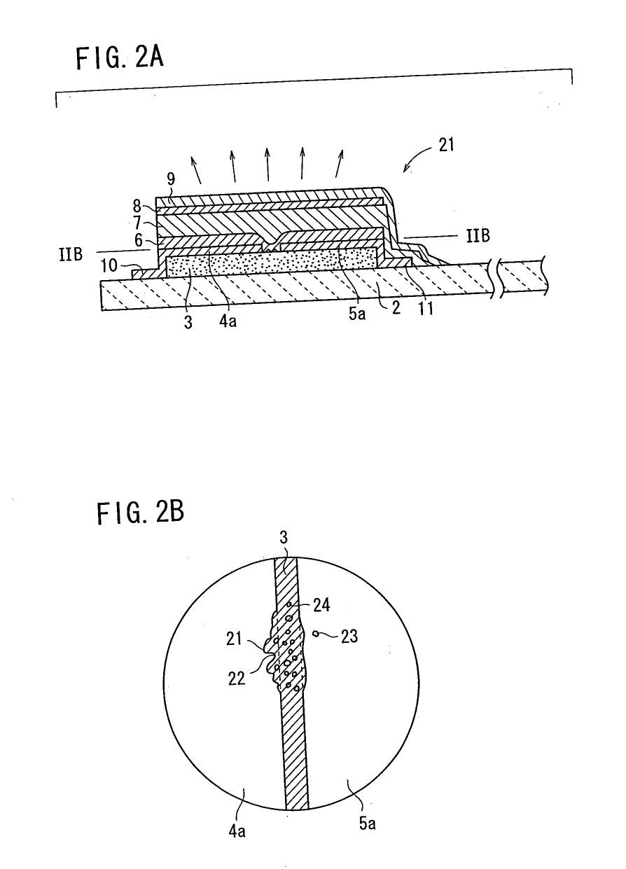

FIG. 2A is a vertical longitudinal sectional view of a light-emitting device according to a second embodiment of the present invention, and FIG. 2B is a cross-sectional view taken alone line IIB-IIB of FIG. 2A. According to the present embodiment, a drive electrode 4a and a common electrode 5a have a concavity 21, a convexity 22, and a pinhole 23. Lands 24 are disposed in the slit in electrically insulated relation to the drive electrode 4a and the common electrode 5a, and are made of a material (e.g., Au) which is identical to the material that the drive electrode 4a and the common electrode 5a are made of.

According to the second embodiment, an electric field is concentrated on the concavity 21, the convexity 22, the pinhole 23, and the lands 24 for facilitating the emission of electrons. Therefore, the drive voltage for the light-emitting device 21 can further be lowered.

The concavity 21, the convexity 22, the pinhole 23, and the lands 24 are formed by making a drive electrode and a common electrode, which are semicircular in shape, of Au with a slit width of 10 μm, for example, on a dielectric material (having a dielectric constant of 5500), and thereafter applying a pulsed voltage of 250 V in 5 μseconds several times to the drive electrode and the common electrode with a resistor of 10 ohms connected between the common electrode and ground. If the light-emitting device shown in FIGS. 2A and 2B is to be used, then a resistor of 10 kilohms connected between the common electrode and ground.

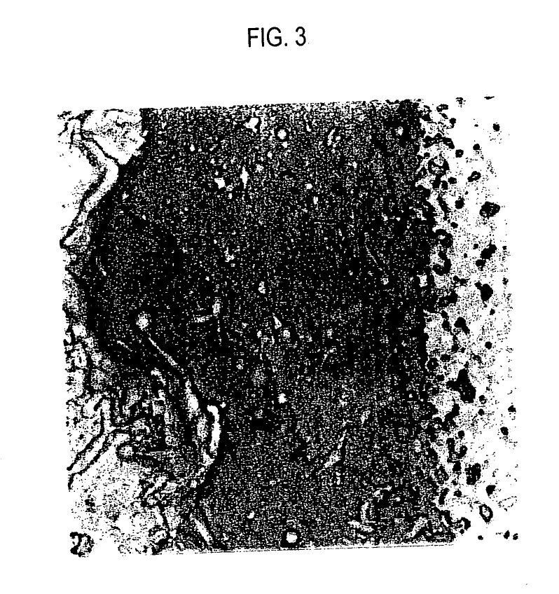

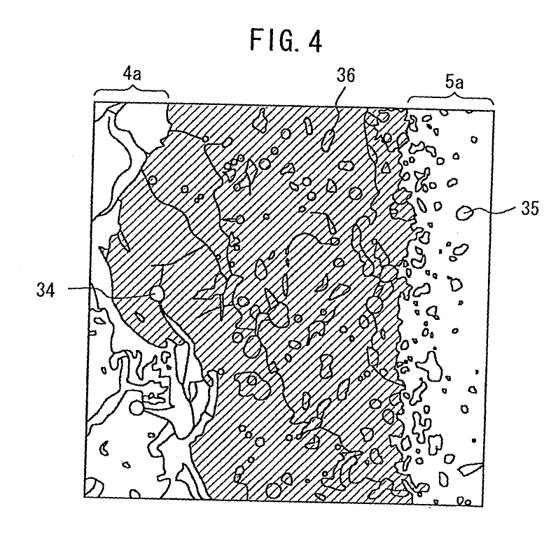

FIG. 3 is an enlarged microscopic photographic representation of a portion of the light-emitting device shown in FIG. 2B, and FIG. 4 is a diagram illustrating the enlarged microscopic photographic representation shown in FIG. 3. In FIG. 4, the slit is shown hatched. The drive electrode 4a has a convexity 34, the common electrode 5a has a pinhole 35, and the slit has lands 36.

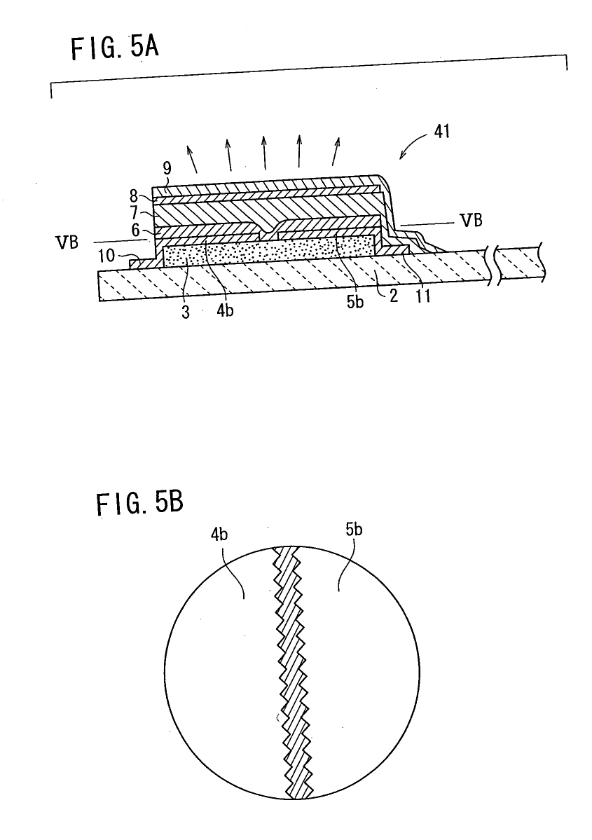

FIG. 5A is a vertical longitudinal sectional view of a light-emitting device according to a third embodiment of the present invention, and FIG. 5B is a cross-sectional view taken alone line VB-VB of FIG. 5A. According to the present embodiment, each of a drive electrode 4b and a common electrode 5b of a light-emitting device 41 has a regularly formed saw-toothed portion facing the slit. Since an electric field is concentrated on the saw-toothed portion, facilitating the emission of electrons, the drive voltage for the light-emitting device 41 can further be lowered.

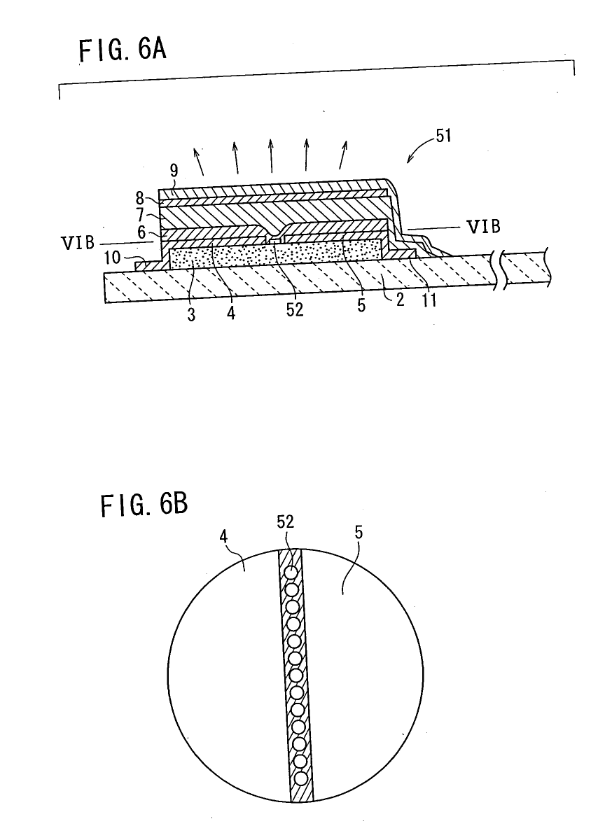

FIG. 6A is a vertical longitudinal sectional view of a light-emitting device according to a fourth embodiment of the present invention, and FIG. 6B is a cross-sectional view taken alone line VIB-VIB of FIG. 6A. According to the present embodiment, a light-emitting device 51 has a regularly arranged array of circular lands 52 in the slit. Since an electric field is concentrated on the lands 52, facilitating the emission of electrons, the drive voltage for the light-emitting device 51 can further be lowered.

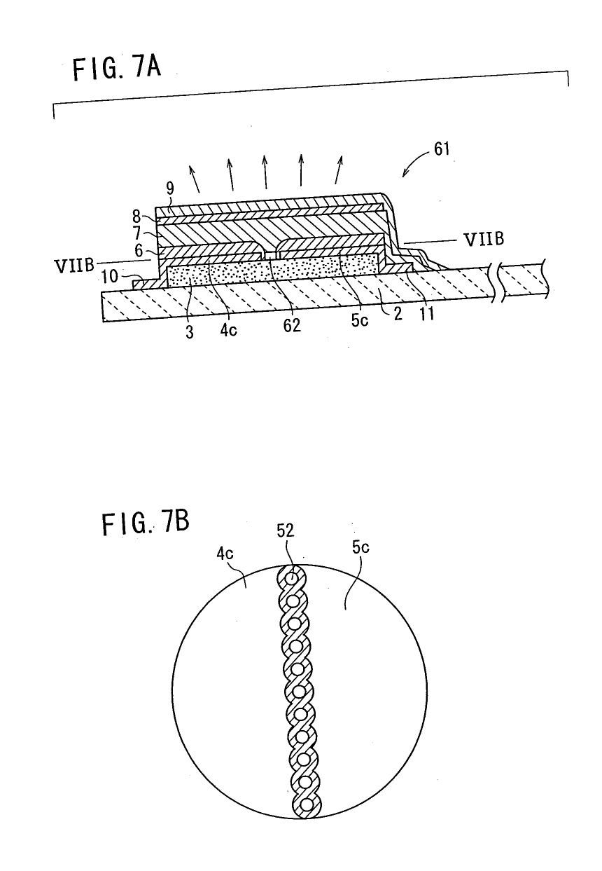

FIG. 7A is a vertical longitudinal sectional view of a light-emitting device according to a fifth embodiment of the present invention, and FIG. 7B is a cross-sectional view taken alone line VIIB-VIIB of FIG. 7A. According to the present embodiment, a light-emitting device 61 has a regularly arranged array of circular lands 62 in the slit and each of a drive electrode 4c and a common electrode 5c has a regularly arranged array of sharp teeth facing the slit. Since an electric field is concentrated on the sharp teeth and the lands 62, facilitating the emission of electrons, the drive voltage for the light-emitting device 61 can further be lowered.

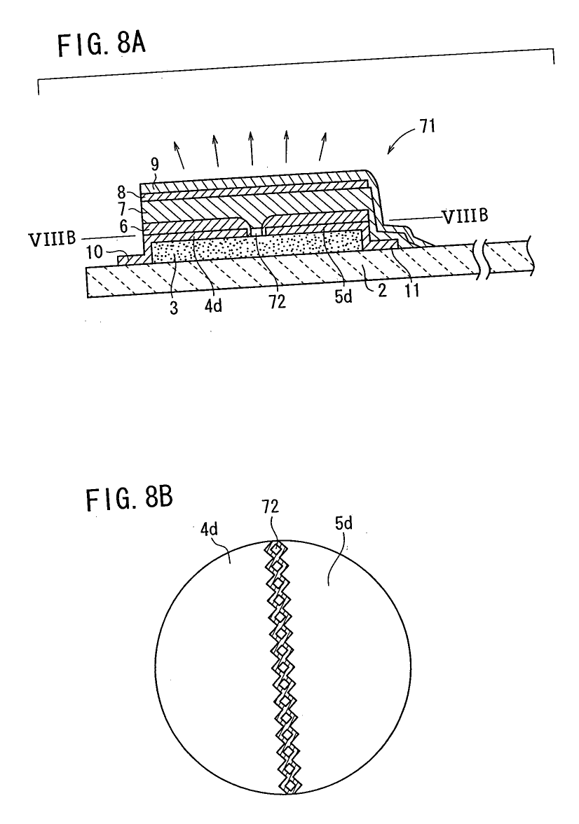

FIG. 8A is a vertical longitudinal sectional view of a light-emitting device according to a sixth embodiment of the present invention, and FIG. 8B is a cross-sectional view taken alone line VIIIB-VIIIB of FIG. 8A. According to the present embodiment, a light-emitting device 71 has a regularly arranged array of rhombic lands 72 in the slit and each of a drive electrode 4d and a common electrode 5d has a regularly formed saw-toothed portion facing the slit. Since an electric field is concentrated on the sharp teeth and the lands 72, facilitating the emission of electrons, the drive voltage for the light-emitting device 71 can further be lowered.

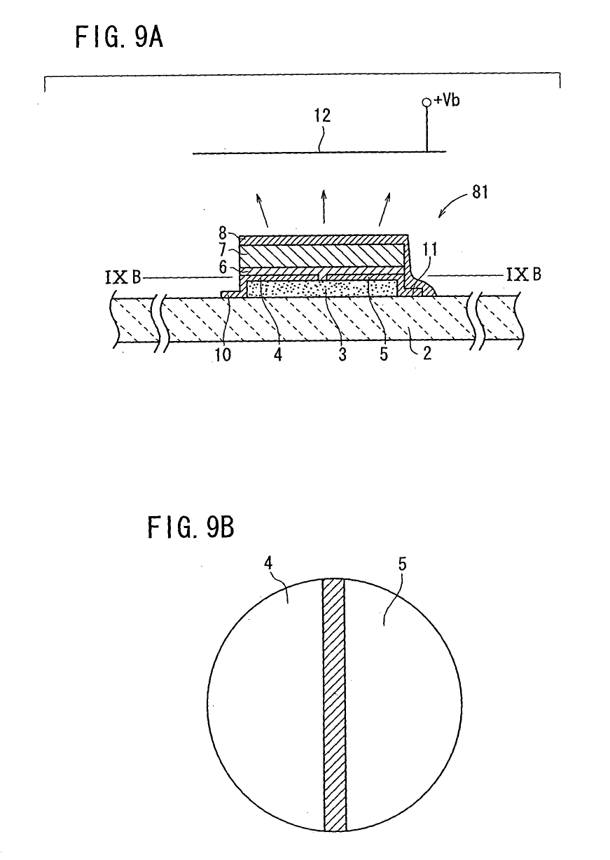

FIG. 9A is a vertical longitudinal sectional view of a light-emitting device according to a seventh embodiment of the present invention, and FIG. 9B is a cross-sectional view taken alone line IXB-IXB of FIG. 9A. A light-emitting device 81 according to the present embodiment has a collector electrode 12 disposed at a predetermined spaced interval from the fluorescent layer 8, instead of the transparent electrode 9 in the first embodiment shown in FIG. 1, and a bias voltage+Vb is applied to the collector electrode 12. Electrons that are emitted when a pulsed voltage is applied to the drive electrode 4 are applied through the electron passage layer 7 to the fluorescent layer 8 when a bias voltage+Vb is applied to the collector electrode 12. The fluorescent layer 8 is excited to emit light as indicated by the arrows.

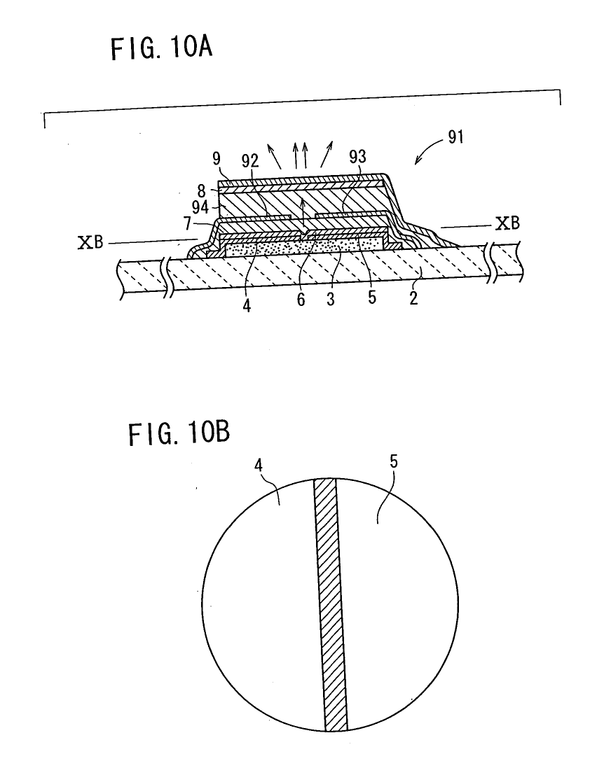

FIG. 10A is a vertical longitudinal sectional view of a light-emitting device according to an eighth embodiment of the present invention, and FIG. 10B is a cross-sectional view taken alone line XB-XB of FIG. 10A. A light-emitting device 91 having a triode structure according to the present embodiment has, in addition to the components of the light-emitting device 1 shown in FIG. 1, gate electrodes 92, 93 as third and fourth electrodes disposed on the electron passage layer 7 for controlling the emission of electrons, and another electron passage layer 94 for passing therethrough the electrons that are controlled by the gate electrodes 92, 93. According to the present embodiment, since the emission of electrons is controlled by the gate electrodes 92, 93, desired light emission characteristics can easily be obtained.

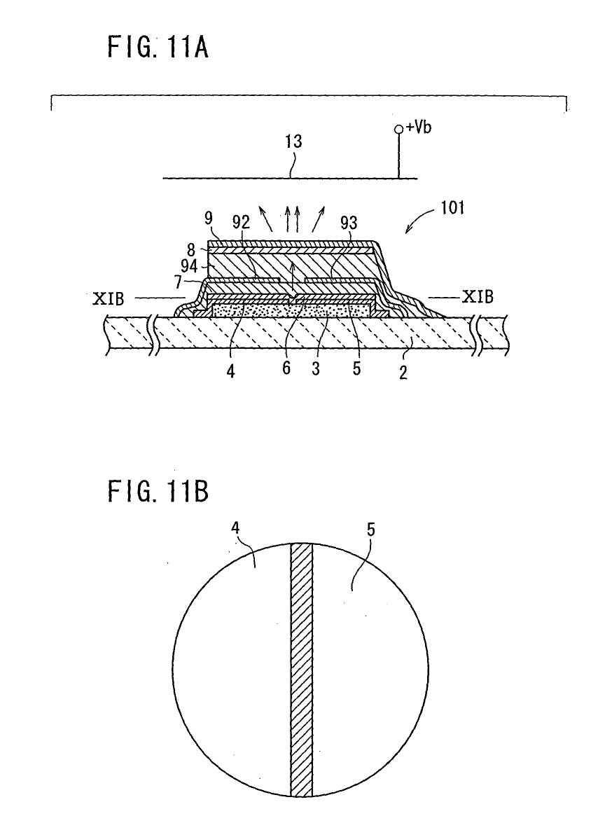

FIG. 11A is a vertical longitudinal sectional view of a light-emitting device according to a ninth embodiment of the present invention, and FIG. 11B is a cross-sectional view taken alone line XIB-XIB of FIG. 11A. A light-emitting device 81 according to the present embodiment has a collector electrode 13 disposed at a predetermined spaced. interval from the fluorescent layer 8, instead of the transparent electrode 9 in the eighth embodiment shown in FIGS. 10 and 10B, and a bias voltage+Vb is applied to the collector electrode 12. Electrons that are emitted when a pulsed voltage is applied to the drive electrode 4 are applied through the electron passage layer 7 to the fluorescent layer 8 when a bias voltage+Vb is applied to the collector electrode 13. The fluorescent layer 8 is excited to emit light as indicated by the arrows.

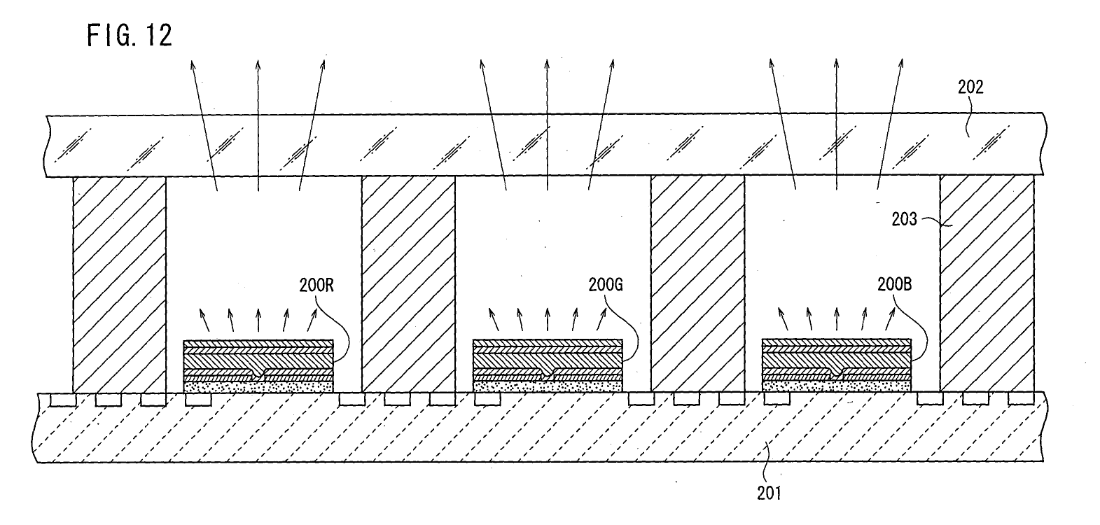

FIG. 12 is a view showing an FED according to an embodiment of the present invention. The FED comprises a two-dimensional array of light-emitting devices 200R, 200G, 200B, a substrate 201 on which the light-emitting devices 200R, 200G, 200B are disposed, a transparent substrate 202 disposed at a predetermined spaced interval from the light-emitting devices 200R, 200G, 200B and made of glass, for example, and spacers 203 which provides a space in the direction of the thickness of the FED.

According to the present embodiment, the light-emitting devices 200R, 260G, 200B employ a red fluorescent body, a green fluorescent body, and blue fluorescent body as a fluorescent layer, and the substrate 201 is made of a material which is the same as the substrate 2 shown in FIG. 1. Each of the light-emitting devices 200R, 200G, 200B has the structure shown in FIG. 1, but may have any of the structures shown in FIGS. 2, 5-11.

According to the present embodiment, since the light-emitting devices 200R, 200G, 200B emit light by themselves when the FED displays information, the FED is not required to have fluorescent bodies, and as a result, it is not necessary to take into account the pitch of fluorescent bodies and to provide a grid. As a consequence, the FED according to the present invention is preferable from the standpoints of higher definition, increased resolution, smaller size, and cost reduction. Furthermore, since the light-emitting devices can be used under the atmospheric pressure, the FED is not required to have a vacuum space therein, a feature which is very advantageous for making the FED low in profile.

The present invention is not limited to the above embodiments, but many changes and modifications may be made therein.

For example, the light-emitting device according to the present invention may be used in other applications than the FED, e.g., high-luminance, high-efficiency light sources such as light sources for use in projectors, chip light sources, traffic signal devices, or alternatives to LEDs such as backlight units in small-size liquid-crystal display units such as cellular phones. For producing a field emission phenomenon, a slit having a width ranging between 0.1 μm and 500 μm may preferably be defined between the drive electrode and the common electrode, a convexity and a concavity which are formed regularly or irregularly to a desired shape with at least one of a straight line and a curved line may be disposed on at least one of the drive electrode and the common electrode, lands may be formed in the slit, and/or the drive electrode and the common electrode may be shaped as desired insofar as at least one of the drive electrode and the-common electrode has a pinhole.

The width d of the slit between the drive electrode and the common electrode will be considered below. In order to reduce the voltage V that is applied to the light-emitting device to cause the light-emitting device to emit electrons, the width of the slit should preferably be relatively small. For emitting electrons, an electric field having a predetermined value E or greater needs to be generated in a location where the electric field is concentrated. Since the electric field E is determined by:

E=V/d

increasing the electric field E needs to increase the voltage V and/or reduce the width d of the slit.

If the voltage V is increased, then (a) since the voltage applied to the drive circuit for the light-emitting device is increased, it is difficult to reduce the size of the drive circuit, and the overall apparatus which has the light-emitting device and the drive circuit therefor becomes expensive to manufacture, and (b) positive ions generated in the plasma atmosphere gains energy under the voltage V, impinges upon the drive electrode, and hence tends to damage the drive electrode.

As a result, for increasing the electric field E, it is preferable to reduce the width d of the slit without increasing the voltage V.

While it is preferable to reduce the width d of the slit as much as possible, according to the present invention, it is not necessary to reduce the width d of the slit so much as with the electron emitter used in the conventional FEDs for the emission of electrons. Specifically, with an electron emitter based on the principles of field emission, the electric field E needs to be of about 5×10⁹ V/m, and the width d of the slit needs to be of 20 nm in order to keep the voltage V at 100 V or less. With the light-emitting device according to the present invention, on the other hand, it is sufficient for the width d of the slit to be of 20 μm in order to keep the voltage V at 100 V or less. As a result, the slit can be formed by an inexpensive slitting and patterning process.

According to the present invention, the width of the slit is in the range between 0.1 μm and 500 μm. For further lowering the applied voltage, the width d of the slit is kept in the range between 0.1 μm and 50 μm, preferably in the range between 0.1 μm and 10 μm, or more preferably in the range between 0.1 μm and 1 μm. With this slit width, the light-emitting device is capable of emitting electrons at a low applied voltage of about 10 V.

For achieving easier machinability and insulation between the first electrode and the second electrode, the width d of the slit may have a lower limit of 0.1 μm. For emitting electrons at a lower voltage, reducing the size of the circuit, and reducing the cost, and from the standpoint of the service life of the drive electrodes, the width d of the slit may have an upper limit of 1 μm.

In the above embodiments, the substrate is made of ceramics. However, the substrate may comprise a glass substrate, a metal plate, or a silicon substrate, or may be made of a dielectric material itself. If a glass substrate is employed, then the light-emitting device may be constructed as a large panel, and the circuit may be fabricated using TFT. If a metal layer is employed, then an insulating layer is required. If a silicon substrate is employed, then the circuit can be formed with ease. If the substrate be made of a dielectric material itself, then the substrate itself serves as an electric field receiving member by itself, and a drive electrode and a common electrode can directly be formed on the substrate.

In the above embodiments, the electrically conductive coating layer is disposed between the drive electrode (first electrode), the common electrode (second electrode), and the slit, and the electron passage layer. However, the electrically conductive coating layer may be dispensed with. According to such a modification, the drive electrode 4 may be made of an electric conductor that is resistant to a high-temperature oxidizing atmosphere, e.g., a pure metal, an alloy, a mixture of insulating ceramics and a pure metal, a mixture of insulating ceramics and an alloy, or the like. Preferably, the electrically conductive coating layer should be made of a precious metal having a high melting point such as platinum, palladium, rhodium, molybdenum, or the like, a material whose main component comprises an alloy of silver and palladium, an alloy of silver and platinum, an alloy of platinum and palladium, or the like, or a cermet of platinum and a ceramics material. More preferably, the electrically conductive coating layer should be made of a material whose main component comprises platinum or a platinum-based alloy. The electrodes may also be made of carbon, a graphite material such as thin-film diamond, diamond-like carbon, carbon nanotube, for example. The ceramics material to be added to the electrode material should preferably be of a proportion ranging from 5 to 30 volume %.

The drive electrode 4 may be formed of any of the above materials according to any of ordinary film forming process, e.g., any of various thick-film forming processes such as screen printing, spraying, electrically conductive coating, dipping, coating, electrophoresis, etc., or any of various thin-film forming processes such as sputtering, ion beam, vacuum evaporation, ion plating, CVD, plating, etc. Preferably, the drive electrode 4 should be formed by any of the above thick-film forming processes.

If the drive electrode 4 is formed by a thick-film forming process, then the thickness of the drive electrode 4 is generally 20 μm or less, preferably 5 μm or less.

The common electrode 5 is made of the same material according to the same process as the drive electrode 4. Preferably, the common electrode 5 should be formed by any of the above thick-film forming processes. The thickness of the common electrode 5 is also generally 20 μm or less, preferably 5 μm or less.

Although certain preferred embodiments of the present invention have been shown and described in detail, it should be understood that various changes and modifications may be made therein without departing from the scope of the present invention.

What is claimed is:

1. A light-emitting device comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
an electron passage layer disposed on said first electrode, said second electrode, and said slit, said electron passage layer being resistant to a predetermined voltage when the predetermined voltage is applied thereto, said electron passage layer being made of a material having such characteristics as to pass electrons therethrough;
a fluorescent layer disposed on said electron passage layer; and
a transparent electrode disposed on said fluorescent layer or a third electrode disposed at a predetermined spaced interval from said fluorescent layer.

2. A light-emitting device according to claim 1, further comprising:
an electrically conductive coating layer interposed between said first electrode, said second electrode, and said slit, and said electron passage layer.

3. A light-emitting device according to claim 1, wherein at least one of said first electrode and said second electrode has at least one of a convexity and a concavity.

4. A light-emitting device according to claim 1, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

5. A light-emitting device according to claim 1, wherein said electric field receiving member has a specific dielectric constant of 1000 or greater.

6. A light-emitting device according to claim 1, wherein said slit has a width in a range between 0.1 μm and 500 μm.

7. A light-emitting device according to claim 6, wherein said slit has a width in a range between 0.1 μm and 50 μm.

8. A light-emitting device according to claim 7, wherein said slit has a width in a range between 0.1 μm and 10 μm.

9. A light-emitting device according to claim 8, wherein said slit has a width in a range between 0.1 μm and 1 μm.

10. A light-emitting device according to claim 1, wherein said electric fielf receiving member is made of a pizoelectric material, an antiferroelectric material, or an electrostrictive material.

11. A light-emitting device comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
a first electron passage layer disposed on said first electrode, said second electrode, and said slit, said first electron passage layer being resistant to a predetermined voltage when the predetermined voltage is applied thereto, said first electron passage layer being made of a material having such characteristics as to pass electrons therethrough;
a third electrode and a fourth electrode which are disposed on said first electron passage layer, for emitting electrons which are emitted from said first electron passage layer;
a second electron passage layer disposed on said first electron passage layer, said third electrode, and said fourth electrode, said second electron passage layer being resistant to a predetermined voltage when the predetermined voltage is applied thereto, said second electron passage layer being made of a material having such characteristics as to pass electrons therethrough;
a fluorescent layer disposed on said second electron passage layer; and
a transparent electrode disposed on said fluorescent layer or a,fifth electrode disposed at a predetermined spaced interval from said fluorescent layer.

12. A light-emitting device according to claim 11, further comprising:
an electrically conductive coating layer interposed between said first electrode, said second electrode, and said slit, and said electron passage layer.

13. A light-emitting device according to claim 11 through 3, wherein at least one of said first electrode and said second electrode has at least one of a convexity and a concavity.

14. A light-emitting device according to claim 11, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

15. A light-emitting device according to claim 11, wherein said electric field receiving member has a specific dielectric constant of 1000 or greater.

16. A light-emitting device according to claim 11, wherein said slit has a width in a range between 0.1 μm and 500 μm.

17. A light-emitting device according to claim 16, wherein said slit has a width in a range between 0.1 μm and 50 μm.

18. A light-emitting device according to claim 17, wherein said slit has a width in a range between 0.1 μm and 10 μm.

19. A light-emitting device according to claim 18, wherein said slit has a width in a range between 0.1 μm and 1 μm.

20. A light-emitting device according to claim 11, wherein said electric fielf receiving member is made of a pizoelectric material, an antiferroelectric material, or an electrostrictive material.

21. A field emission display comprising a two-dimensional array of light-emitting devices, each of said light-emitting devices comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
an electron passage layer disposed on said first electrode, said second electrode, and said slit, said electron passage layer being resistant to a predetermined voltage when the predetermined voltage is applied thereto, said electron passage layer being made of a material having such characteristics as to pass electrons therethrough;
a fluorescent layer disposed on said electron passage layer; and
a transparent electrode disposed on said fluorescent layer or a third electrode disposed at a predetermined spaced interval from said fluorescent layer.

22. A field emission display according to claim 21, further comprising:
an electrically conductive coating layer interposed between said first electrode, said second electrode, and said slit, and said electron passage layer.

23. A field emission display according to claim 21, wherein at least one of said first electrode and said second electrode has at least one of a convexity and a concavity.

24. A field emission display according to claim 21 through 15, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

25. A field emission display according to claim 21, wherein said electric field receiving member has a specific dielectric constant of 1000 or greater.

26. A field emission display according to claim 21 through 17, wherein said slit has a width in a range between 0.1 μm and 500 μm.

27. A field emission display according to claim 26, wherein said slit has a width in a range between 0.1 μm and 50 μm.

28. A field emission display according to claim 27, wherein said slit has a width in a range between 0.1 μm and 10 μm.

29. A field emission display according to claim 28, wherein said slit has a width in a range between 0.1 μm and 1 μm.

30. A field emission display according to claim 21, further comprising:
a substrate, said two-dimensional array of light-emitting devices being integrally formed with said substrate.

31. A field emission display according to claim 21, wherein said electric fielf receiving member is made of a pizoelectric material, an antiferroelectric material, or an electrostrictive material.

32. A field emission display comprising a two-dimensional array of light-emitting devices, each of said light-emitting devices comprising:
an electric field receiving member made of a dielectric material;
a first electrode disposed on one surface of said electric field receiving member;
a second electrode disposed on said one surface of said electric field receiving member, said second electrode and said first electrode jointly defining a slit;
a first electron passage layer disposed on said first electrode, said second electrode, and said slit, said first electron passage layer being resistant to a predetermined voltage when the predetermined voltage is applied thereto, said first electron passage layer being made of a material having such characteristics as to pass electrons therethrough;
a third electrode and a fourth electrode which are disposed on said first electron passage layer, for emitting electrons which are emitted from said first electron passage layer;
a second electron passage layer disposed on said first electron passage layer, said third electrode, and said fourth electrode, said second electron passage layer being resistant to a predetermined voltage when the predetermined voltage is applied thereto, said second electron passage layer being made of a material having such characteristics as to pass electrons therethrough;
a fluorescent layer disposed on said second electron passage layer; and
a transparent electrode disposed on said fluorescent layer or a fifth electrode disposed at a predetermined spaced interval from said fluorescent layer.

33. A field emission display according to claim 32, further comprising:
an electrically conductive coating layer interposed between said first electrode, said second electrode, and said slit, and said electron passage layer.

34. A field emission display according to claim 32, wherein at least one of said first electrode and said second electrode has at least one of a convexity and a concavity.

35. A field emission display according to claim 32, further comprising at least one of a pinhole defined in at least one of said first electrode and said second electrode, and a land disposed in said slit in electrically insulated relation to said first electrode and said second electrode and made of a material which is the same as the material of said first electrode and said second electrode.

36. A field emission display according to claim 32, wherein said electric field receiving member has a specific dielectric constant of 1000 or greater.

37. A field emission display according to claim 32, wherein said slit has a width in a range between 0.1 μm and 500 μm.

38. A field emission display according to claim 37, wherein said slit has a width in a range between 0.1 μm and 50 μm.

39. A field emission display according to claim 38, wherein said slit has a width in a range between 0.1 μm and 10 μm.

40. A field emission display according to claim 39, wherein said slit has a width in a range between 0.1 μm and 1 μm.

41. A field emission display according to claim 32, further comprising:
a substrate, said two-dimensional array of light-emitting devices being integrally formed with said substrate.

42. A field emission display according to claim 32, wherein said electric fielf receiving member is made of a pizoelectric material, an antiferroelectric material, or an electrostrictive material.
